(19) United States
(12) Patent Application Publication
(10) Pub. No.: US 2024/0163156 A1
(43) Pub. Date: May 16, 2024

(54) SMART DEVICE RANKING FOR PERFORMANCE MONITORING

(71) Applicant: Comcast Cable Communications, LLC, Philadelphia, PA (US)

(72) Inventors: Yonatan VAIZMAN, Washington, DC (US); Hongcheng WANG, Arlington, VA (US)

(21) Appl. No.: 18/054,440

(22) Filed: Nov. 10, 2022

(51) Int. Cl. H04L 41/0604; H04L 41/16; H04L 43/062; H04L 43/065

(52) U.S. Cl. CPC H04L 41/0627; H04L 41/16; H04L 43/062; H04L 43/065

(57) ABSTRACT

Methods, devices, and systems for smart device ranking for maintenance and troubleshooting is described herein. Devices of a network may be ranked based on a likelihood or probability that a given device is experiencing a connectivity issue or is likely to be tested in the personal network. A machine learning engine may collect various telemetry data from various devices, which may include troubleshooting data from various personal networks. The machine learning engine may train a model according to the received telemetry data. The trained model may be implemented for a given personal network. The trained model may receive telemetry data for the given personal network, and may generate a ranking value for the devices of the personal network. The ranking value may be generated according to a probability that the device is experiencing a connectivity issue at a given time.

### BACKGROUND

Personal networks, and other wireless local area networks (WLANs), often provide a user with troubleshooting processes for identifying connectivity issues related to the individual devices connected to the personal network. For example, if a user experiences slow download speed for a given device of a personal network, the user may open a troubleshooting application, which may test the download speed for various devices in the personal network.

However, these troubleshooting processes typically display the various devices of the personal network to the user in a random or unordered listing. The incorporation of IoT devices into personal networks has further increased the typical number of devices connected to a given personal network. Further, individual device names (e.g., as viewed in the troubleshooting application) may be random, or technologically pertinent (e.g., an IP address, device type number, etc.), such that a user may not identify the device based on the name provided. Thus, in the case where the troubleshooting process tests each device, the ordering in which the process performs the testing may be random, or may be based on a variable that is uncorrelated to the underlying potential for a given device to be experiencing a connectivity issue. Likewise, even in the case where the troubleshooting process allows for the user to pick and choose which devices to test, the user may not be able to identify which devices to test, due to how the troubleshooting process (e.g., via an application) is displayed to the user. These and other shortcoming are addressed by the present disclosure.

### SUMMARY

The following summary is for example purposes only, and is not intended to limit or constrain the detailed description.

According to the present disclosure, devices of a personal network (or other WLAN) may be ranked based on a likelihood or probability that a given device is experiencing a technical issue, such as a connectivity issue, or is likely to perform a diagnostic test, such as a speed test, in the personal network. A machine learning model may receive various telemetry data from various devices, which may include troubleshooting data from various personal networks. The model may be trained according to the received telemetry data. The trained model may be implemented for a given personal network. The trained model may receive telemetry data for the given personal network, and may generate ranking values for the devices of the personal network. The ranking values may be generated according to a probability that the device is experiencing a connectivity issue at a given time. In some cases, the ranking value may be generated according to a probability that a user is using the device at a given time.

When a user implements a testing, maintenance, or troubleshooting procedure (e.g., via opening a troubleshooting application), the trained model may generate the ranked devices and send the rankings to a user device (e.g., that the user used to open the troubleshooting application), which may display the ranked devices in an ordered list according to their respective ranking values. Thus, the devices of the personal network may be displayed to a user according to a likelihood that a particular device is experiencing a connectivity issue, or based on an importance the device is to the user at the time the user implements the troubleshooting procedure. In the case where a user may selectively test devices, the rankings may assist the user in selecting a device for testing (e.g., the devices the user will likely select for testing will be at the top of the page). In the case where the troubleshooting procedure tests each device, the devices may be tested in an order that may identify first those experiencing connectivity issues, or may test first those most important to the user (e.g., providing test results for devices that the user particularly wishes to see).

The trained model may also be further refined based on the personal network the trained model is associated with. For example, the trained model may be initially trained over a number of personal networks. The model may be associated with a particular personal network. The model may thus receive additional telemetry data from the devices of the particular personal network, which may further refine the trained model, causing the trained model to be more specific to the particular personal network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

These and other features, aspects, and advantages of the present disclosure will become better understood with regard to the following description, claims, and drawings. The present disclosure is presented by way of example, and not limited by, the accompanying drawings in which like numerals indicate similar elements.

FIG. 1 shows an example communication network.

FIG. 2 shows an example computing device.

FIG. 3 shows an example configuration for a system.

FIG. 4 shows an example method.

FIG. 5 shows an example method.

FIG. 6 shows an example method.

### DETAILED DESCRIPTION OF ILLUSTRATIVE EMBODIMENTS

A system may generate a trained model for ranking devices of a network based on various telemetry data for devices across different networks. Parameters such as RSSI, PHY layer bit rates, upload and download traffic volume, radio channel utilization rates, outside network interference rates, frequency band usage, channel usages, and device type, may act as input to train the model.

When a troubleshooting procedure is initiated for a personal network, telemetry parameters for devices of the personal network may be inputted into the trained model. The telemetry data may be the most recently collected from the personal network, and may be collected at the time the troubleshooting procedure is initiated. Based on the telemetry parameters, the model may generate a likelihood score for one or more of the devices for the personal network. The likelihood may correspond to a likelihood that a particular device is experiencing a connectivity issue, or on a likelihood that a user will troubleshoot the device at the time of initiating the troubleshooting process. The scores may be sent to a particular device, such as a device which initiated the troubleshooting procedure (e.g., a mobile phone of a user). The scores may be used to create an ordered list, or ranking, of the devices of the personal network (e.g., highest value scores to lowest value scores). The ordered list may be displayed to the user for selection of devices to troubleshoot, or may be provided as the order of devices the troubleshooting procedure executes through.

In some examples, the trained model may be trained and refined based on telemetry data collected in an associated network. The trained model may be initially trained across various personal networks, which may initially provide a universal model applicable to various individual personal networks. However, once trained, the model may be associated or limited to interacting with a particular personal network. The trained model may be refined and tailored to the devices and telemetry data of the associated network, which may increase the accuracy of the model for the associated network.

As an example, a user may open a troubleshooting app for a personal network. The personal network may include a variety of devices and device types, such as mobile phones, personal computers, laptops, wireless printers, cameras, security devices, TVs, and the like. By opening the app, or in some cases by the user selecting a troubleshooting option, a trained model may generate ranking scores for the devices of the personal network (e.g., based on recently collected telemetry data for the personal network). The user may, at the time of initiating the troubleshooting process, be using one or more of the devices of the personal network, such as a personal computer. This may be reflected in the telemetry parameters of the personal network (e.g., the personal computer bit rate usage is atypically high at that point in time). The trained model may thus rank the personal computer higher in the ranking list based on the user using the personal computer at the time the troubleshooting process is initiated (as reflected in the telemetry data). Thus, when the troubleshooting process begins testing each individual device (in the case where the troubleshooting process tests each device in order), the personal computer may be tested relatively early in the process. This may provide test results for the personal computer relatively early as well, which may be beneficial for the user who may be particularly concerned about the devices which he/she is currently using (as opposed to, for example, IoT devices that are part of the personal network).

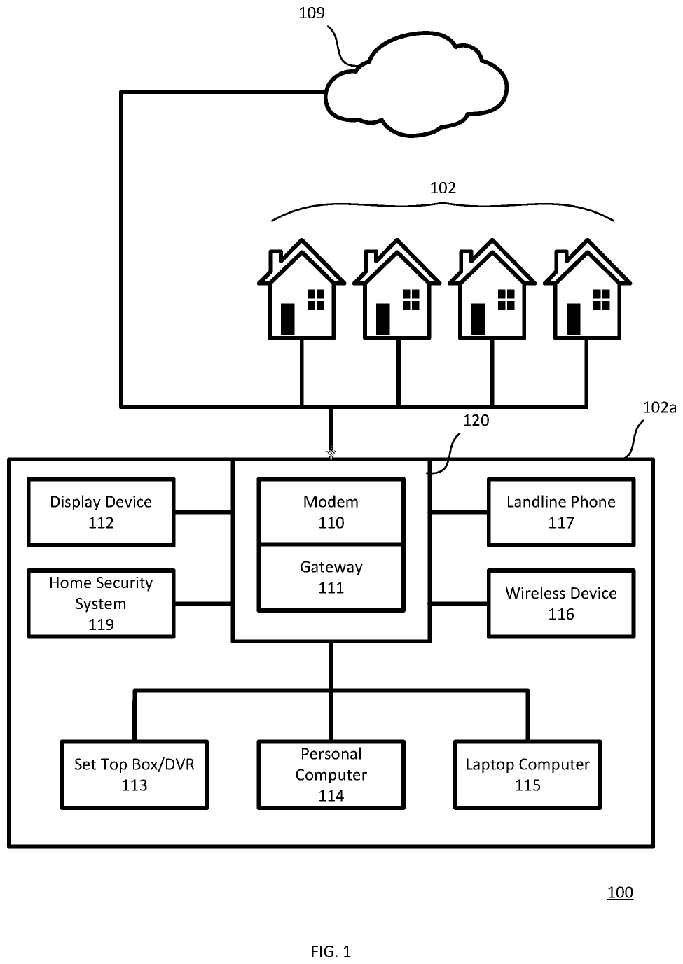

FIG. 1 shows an example communication network 100 on which many of the various features described herein may be implemented. Network 100 may be any type of information distribution network, such as satellite, telephone, cellular, wireless, etc. One example may be an optical fiber network, a coaxial cable network, or a hybrid fiber/coax distribution network. Such networks 100 may use a series of interconnected communication links (e.g., coaxial cables, optical fibers, wireless, etc.) to connect multiple premises 102 (e.g., businesses, homes, consumer dwellings, etc.) to an external network 109. The external network 109 may transmit downstream information signals via the links, and each premises 102 may have a receiver used to receive and process those signals.

The links may include components not shown, such as splitters, filters, amplifiers, etc. to help convey the signal clearly. Portions of the links may also be implemented with fiber-optic cable, while other portions may be implemented with coaxial cable, other lines, or wireless communication paths.

The external network 109 may be configured to place data on one or more downstream frequencies to be received by modems at the various premises 102, and to receive upstream communications from those modems on one or more upstream frequencies. The network 109 may include, for example, networks of Internet devices, telephone networks, cellular telephone networks, fiber optic networks, local wireless networks (e.g., WiMAX), satellite networks, and any other desired network.

An example premises 102a, such as a home, may include an interface 120 for creating a personal network at the premises 102a. The interface 120 may include any communication circuitry needed to allow a device to communicate on one or more links with other devices in the network. For example, the interface 120 may include a modem 110, which may include transmitters and receivers used to communicate on the links and with the external network 109 The modem 110 may be, for example, a coaxial cable modem (for coaxial cable lines), a fiber interface node (for fiber optic lines), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. Further, the interface 120 may include a gateway interface device 111. The modem 110 may be connected to, or be a part of, the gateway interface device 111. The gateway interface device 111 may be one or more computing devices that communicate with the modem(s) 110 to allow one or more other devices in the premises 102a, to communicate with the network 109. The gateway 111 may be a set-top box (STB), digital video recorder (DVR), computer server, or any other desired computing device. The gateway 111 may also include (not shown) local network interfaces to provide communication signals to requesting entities/devices in the premises 102a, such as display devices 112 (e.g., televisions), additional STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), IoT devices such as security system devices 119, and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

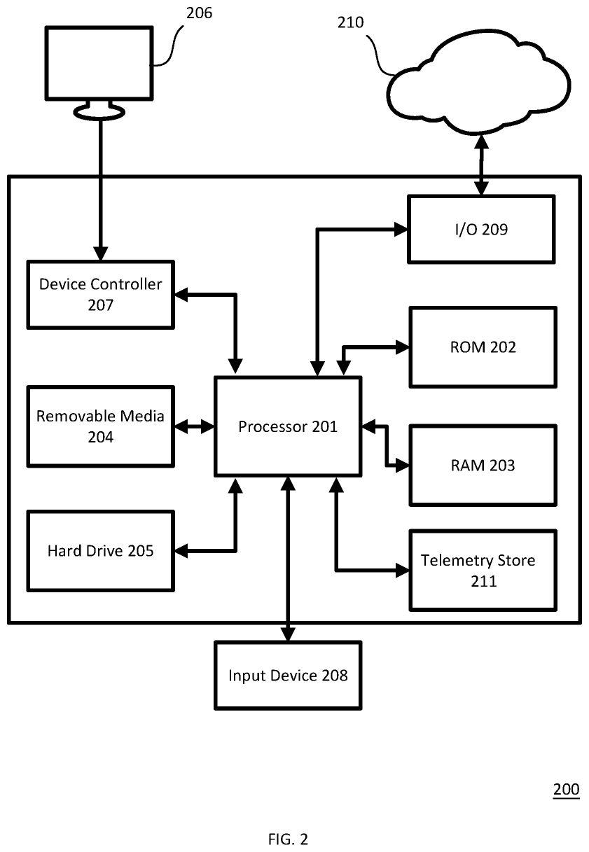

Having described an example communication network shown in FIG. 1 in which various features described herein may be implemented, an example computing device as shown in FIG. 2 will be described.

FIG. 2 shows general hardware elements that may be used to implement any of the various systems or computing devices discussed herein. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired storage medium. Instructions may also be stored in an attached (or internal) hard drive 205. The computing device 200 may include one or more output devices, such as a display 206 (e.g., an external television), and may include one or more output device controllers 207, such as a video processor. There may also be one or more user input devices 208, such as a remote control, keyboard, mouse, touch screen, microphone, camera input for user gestures, etc. The computing device 200 may also include one or more network interfaces, such as a network input/output (I/O) circuit 209 (e.g., a network card) to communicate with an external network 210 (e.g., the personal network of premises 102a). The network input/output circuit 209 may be a wired interface, wireless interface, or a combination of the two. In some examples, the network input/output circuit 209 may include a modem (e.g., a cable modem), and the external network 210 may include the communication links 101 discussed above, the external network 109, an in-home network, a provider's wireless, coaxial, fiber, or hybrid fiber/coaxial distribution system (e.g., a DOCSIS network), or any other desired network. Additionally, in some examples the device may be configured to implement one or more aspects discussed herein. For example, the device may include a telemetry store 211, which may be configured to receive, store, and send information regarding telemetry data or measurements taken at the device and/or in the network, and associated context. In some cases, the device may be configured to measure telemetry data for the device, and/or store telemetry data for the device 200 and/or other devices in the personal network. The real-time data store 211 may utilize other components of the device, such as hard drive 205, removable media 204, and/or RAM 203. Further, in some cases, the device 200 may also be configured to store and execute a trained model for ranking devices of the personal network, as discussed in more detail below.

The FIG. 2 example is a hardware configuration, although the shown components may be wholly or partially implemented as software as well. Modifications may be made to add, remove, combine, divide, etc. components of the computing device 200 as desired. Additionally, the components shown may be implemented using basic computing devices and components, and the same components (e.g., processor 201, ROM storage 202, display 206, etc.) may be used to implement any of the other computing devices and components described herein. For example, the various components herein may be implemented using computing devices having components such as a processor executing computer-executable instructions stored on a computer-readable medium, as shown in FIG. 2. Some or all of the entities described herein may be software based, and may co-exist in a common physical platform.

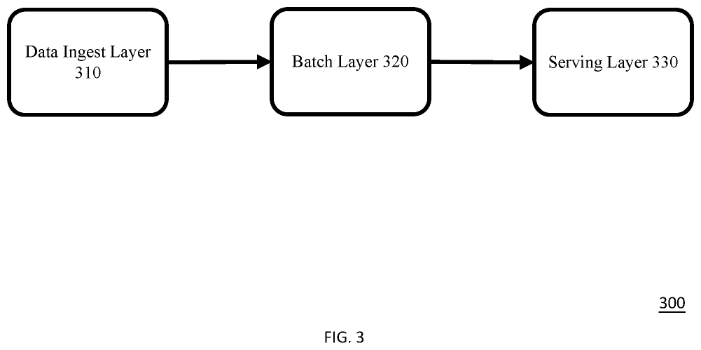

Having discussed example communication systems, networks and computing devices, discussion will now turn to an operating environment in which the various techniques described herein may be implemented, as shown in FIG. 3.

FIG. 3 shows an example configuration 300 which may be used in implementing one or more aspects described herein regarding ranking devices for troubleshooting procedures. For example, the configuration 300 may be implemented in a communication network such as that shown in FIG. 1 to provide improved device rankings of a personal network for troubleshooting. The software architecture may include a data ingest layer 310, a batch layer 320, and a serving layer 330. The layers and modules that make up the software architecture of configuration 300 may be implemented by one or more computing devices, such as computing device 200 as shown in FIG. 2. In some examples, the software architecture may be implemented in whole or in part by one or more servers associated with a service provider, such as servers located in the external network 109 as shown in FIG. 1.

The data ingest layer 310 may be configured to retrieve, process, and/or store telemetry data or parameters for devices in one or more personal networks. The telemetry parameters may include RSSI, PHY layer bit rates, upload and download traffic volume, radio channel utilization rates, outside network interference rates, frequency band usage, channel usages, device type, and the like. The telemetry data may be collected by a gateway of the personal network, such as the gateway 111 of FIG. 1, and sent to the data ingest layer 310. This may be beneficial, particularly as the gateway may be used for inflow and outflow of communications to the personal network. In some cases, the gateway may prompt the devices of the personal network to send telemetry data to the gateway. For example, the gateway may send a request to the devices of the personal network for the telemetry data. The devices may each measure or identify various telemetry data (e.g., RSSI, device type, traffic volume, PHY layer bit rates, and the like), and send the data in response to the request. However, in some cases, the gateway may more efficiently identify some of the telemetry data for a given device. For example, channel utilization rates, frequency band usage, and the like, may be more easily determined by the gateway, which may have a more complete perspective of channel and frequency usage within the personal network. The gateway may collect and send the telemetry data for one or more devices of the personal network to the data ingest layer 310.

In some cases, other entities may receive the telemetry data. For example, devices of the personal network may provide telemetry data as communications, such that each device may monitor its own telemetry data and send the data to the data ingest layer 310 (e.g., via a control uplink channel or channels). In cases where telemetry data are more easily measured or identified by a gateway (or other device in the network), a device of the personal network may send a request to the gateway for telemetry data associated with the device. The gateway may, in response, send any telemetry data the gateway has measured or identified for the device, to the device.

The telemetry data may also include time periods for reception or collection of the telemetry data. For example, each collection of telemetry data may include a timestamp for the collection, such as time and date. In other cases, the data ingest layer 310 may provide a timestamp at the time of receiving the telemetry data. The time period itself may also be utilized as telemetry data, which may be beneficial for implementing a time dependency for a model generated by the configuration 300 (e.g., different times of day may result in different device rankings for a personal network).

In some cases, the telemetry data for a device may be sent to the data ingest layer 310 asynchronously. For example, telemetry data for a device of a personal network may be sent to the data ingest layer 310 when a troubleshooting procedure is initiated for the personal network. In some cases, a troubleshooting procedure is initiated when the troubleshooting procedure is selected or opened on a device (e.g., by a user). Once the troubleshooting procedure is initiated, a broadcast may be sent through the personal network (e.g., relayed to the gateway and broadcasted) requesting telemetry data from the various devices of the personal network. The data ingest layer 310 may thus receive the telemetry data for the various devices.

In some cases, the telemetry data for a device may be sent to the data ingest layer 310 synchronously. For example, the devices in the personal network may be notified of a sampling rate for various telemetry data (e.g., RSSI sample rate). The devices may measure or identify the various telemetry data according to the sampling rate (or sampling rates), and send the data to the data ingest layer 310.

The data ingest layer 310 may receive telemetry data from different personal networks. For example, the data ingest layer 310 may receive telemetry data from a plurality of devices that may or may not include multiple personal networks. In some cases, the data ingest layer 310 may combine the telemetry data from devices of multiple personal networks to generate aggregated telemetry data for use by batch layer 320 and serving layer 330. In some cases, the aggregated telemetry data generated by the data ingest layer 310 may be stored for future batch processing by the batch layer 320.

The data ingest layer 310 may also receive troubleshooting results for devices of the one or more personal networks. For example, a troubleshooting procedure may include testing a connectivity of at least one device. The troubleshooting procedure may include testing a latency time period for a device, a download speed for a device, and/or an upload speed for a device. For a latency test, a device may send a message to a designated service or server (e.g., of external network 109 of FIG. 1). The designated service or server may respond to the message, such as with an acknowledgement message. The round-trip time of the device message sending and response reception may be the latency for the device. For download speed, a device may send a request for data to a designated service or server. The designated service or server may send a portion of data to the device. Once the portion of data is downloaded, the device may request another portion of data from the designated service or server, and the download process may continue. This process may repeat for a predetermined amount of time, at which point the download speed for the device may be calculated based on the amount of data the device downloaded over the predetermined time span. An upload speed test may be similar to the download speed test, except whereas the device receives the data portion in the download speed test, for the upload speed test the device may send portions of data to the designated service or server for a predetermined period of time. The upload speed for the device may be calculated based on the amount of data the device uploaded over the predetermined time span.

Troubleshooting test results for devices of one or more personal networks may be sent to the data ingest layer 310 and treated as telemetry data. These results may be beneficial for generating a trained model. The troubleshooting test results may be particularly beneficial for verifying the value and weights provided to other telemetry data parameters, as a trained model may in some cases rank devices based on a likelihood that devices are experiencing connectivity issues at the time of a troubleshooting procedure.

Historical features of personal networks may also be treated as telemetry data received by the ingest layer 310. For example, historical features may include internet usage patterns for the personal network (e.g., total usage volume, amount percentage across devices at a given time, and the like).

The batch layer 320 may utilize the telemetry data collected by data ingest layer 310 to generate a trained model for ranking devices of a personal network for troubleshooting procedures. The batch layer 320 may use machine learning and/or other forms of semantic analysis to assess historical telemetry data, and provide weights to various telemetry data parameters based on determinations made regarding the devices of a personal network. For example, the batch layer 320 may implement Naïve Bayes Classifier, Support Vector Machine, Linear Regression, Logistic Regression, Artificial Neural Network, Decision Tree, Random Forest, Nearest Neighbor, and the like, as the algorithmic process for generating a model.

While training the model, the batch layer 320 may match telemetry data input features to output labels. The batch layer 320 may adjust weights provided to the telemetry data parameters. The batch layer 320 may also compare telemetry data parameters across personal networks, which may further lead to adjustment of weights provided to telemetry data parameters. This process may occur through multiple iterations, and across multiple personal networks, to generate a trained model for ranking devices.

The model may be trained according to the various desired queries. For example, the model may be trained to determine what a connection speed of a device in a personal network is if the device were to be immediately tested. In this example, a history of cases of users running a device-speedtest (e.g., blasting a device with Xfi's WiFi Blaster) may be inputted into the model. For each case, a measured connection speed may be collected, and may be matched with a recent telemetry report collected for the device prior to the conducted test (for measuring the speed). Such a prediction may be a regression task (since the output label may be a continuous number).

In some cases, the model may be trained to classify devices of a personal network based on high or low connection speeds. A history of cases where the user ran a device-speedtest for the personal network may be collected and matched to results with the telemetry features from the most recent telemetry report before the test is conducted.

In some cases, the model may be trained to determine whether a device of the personal network will undergo a troubleshooting procedure. Data corresponding to troubleshooting procedures being conducted for a particular device may be matched with telemetry data parameters for the devices of the personal network prior to the initiation of the troubleshooting procedure.

In some cases, the model may be trained to determine whether a device of the personal network will be selected to undergo a troubleshooting procedure. Data corresponding to situations where a user selects a particular device for troubleshooting (e.g., including those devices which were not selected for troubleshooting), may be matched with telemetry parameters for the devices of the personal network prior to the selection.

In some cases, the model may be trained (e.g., via batch layer 320) to output a score for each device of a personal network. For example, input to the model may include telemetry data for a particular device, and a sequence of per-device features that represent other devices in the personal network. The mode may implement convolutional neural network layers to summarize context of the other devices and combine the context with the target device features to determine a classification for the target device (e.g., will a user troubleshoot the target device?”).

In some cases, examples from the above may be combined to form an aggregated trained model. For example, scores from the separate initial models may be combined, for example, via averaging, geometric-means, minimal/maximal selection of scores, and the like. Likewise, in some cases, a model may include several, separate models, where a particular model is implemented based on the circumstance. For example, if a full network test is initiated as the troubleshooting procedure, a model trained to determine what a connection speed of a device in a personal network is if the device were to be immediately tested, may be utilized. However, if a “troubleshoot a device” option is selected, where individual devices may be selected for troubleshooting, a model trained to determine whether a device of the personal network will be selected to undergo a troubleshooting procedure may be selected.

Once a model is trained (e.g., via the batch layer 320), the trained model may in some cases be assigned to a particular personal network, for example premises 102a of FIG. 1. In some cases, once assigned, the trained model may be limited to receiving telemetry data of the corresponding personal network. However, in other cases, the trained model may be implemented across multiple personal networks.

Further, the trained model may be implemented by the devices or entities (e.g., of the network 100) that implemented the training of the model. In other cases, the trained model may be sent to other devices or entities for implementation once trained. For example, if the model is trained on entities or devices in the external network 109, the trained model may be sent to a device of the personal network (e.g., of premises 102a) for implementation, such as the corresponding gateway 111 or a wireless device 116.

The batch layer 320 may update or adjust a trained model based on telemetry data received after the model is implemented. For example, the batch layer 320 may receive a set of telemetry data for a particular personal network. The batch layer 320 may input the telemetry data into the trained model, which may output likelihood scores of the devices of the particular personal network (e.g. to the serving layer 330). As any corresponding troubleshooting procedure is implemented (e.g., the determination of whether any of the device of the personal network are currently experiencing a connectivity issue), the batch layer 320 may receive these troubleshooting results and input the results, along with the previously received telemetry parameters, into the trained model for further training. Thus, in cases where the trained model is assigned to a particular personal network, the trained model may be updated or adjusted to be more attuned to the corresponding personal network.

In response to an implementation of a troubleshooting procedure, the serving layer 330 may receive or pull results from the trained model (e.g., of the batch layer 320) and generate an output for the configuration 300. For example, the serving layer 330 may query the trained model according to the corresponding personal network that the troubleshooting procedure is initiated in. The personal network may include particular devices (e.g., personal computers, mobile phones, security cameras, and the like). The serving layer 330 may query the trained model for likelihood scores according to the particular devices associated with the personal network. The serving layer 330 may send the scores (e.g., score values corresponding to particular devices) to a designated device, such as the device initiating the troubleshooting procedure, which may generate an ordered list of the devices based on the scores. In some cases, the serving layer 330 may generate the ordered list of devices based on the likelihood scores, and send the ordered list to a recipient device. In some cases, the configuration 300 is located on the corresponding device, and as such the sending may include sending the results to another section of the device (e.g., a display). Further, the rankings generated from the likelihood scores may be designed or formatted (e.g., by the serving layer 330) for the corresponding recipient device. For example, the recipient device may display the ranked device names via a display of the device. However, other output formats may be utilized as well, such as an audio formatting, and the like.

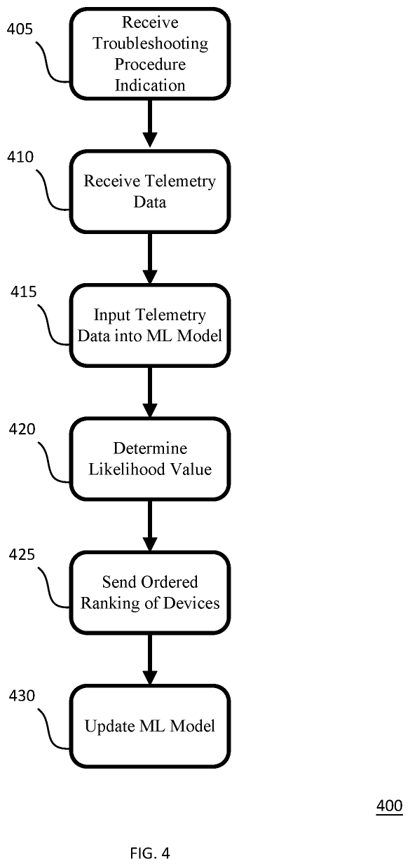

FIG. 4 shows an example method 400 for smart device ranking as discussed herein. The method of FIG. 4 may be implemented in one or more computing devices, such as computing device 200 of FIG. 2. In some cases, the method of FIG. 4 may be implemented by a processor of the one or more computing devices, and executable instructions according to the method may be stored on a memory of the one or more computing devices. The one or more computing devices may be part of a network, such as network 100 or of a personal network of a premises 102 of FIG. 1. The process may be implemented in a network environment having multiple users and respective user devices such as set-top boxes, smart televisions, tablet computers, smartphones, and/or any other suitable access device (e.g., display device 112, gateway 111, personal computer 114, wireless device 116, etc.), or any other desired computing devices. The shown method may in some cases be performed by one or more computing devices in the network. Although the steps of the method may be described with regard to a computing device, it should be understood that the various steps of the method may be handled by different computing devices without departing from the aspects and features described herein.

At Step 405, a computing device may receive an indication that a troubleshooting procedure is initiated for a wireless network comprising a plurality of devices. The troubleshooting procedure may be initiated by a device within the wireless network, such as a mobile phone of a user. The indication may in some cases be a request for an ordered ranking of the personal devices of the wireless network. In some cases, the indication may be a notice that a troubleshooting application or service was opened or activated. The wireless network may be a personal network, such as a network for premises 102a of FIG. 1. A troubleshooting procedure may include testing a connectivity of at least one device. The troubleshooting procedure may include testing a latency time period for a device, a download speed for a device, and/or an upload speed for a device.

The plurality of personal device may include devices wiredly or wirelessly connected in a personal network, such as display devices 112 (e.g., televisions), additional STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), IoT devices such as security system devices, and any other desired devices.

At Step 410, the computing device may receive a plurality of telemetry data corresponding to the plurality of devices. The telemetry data may include RSSI, physical layer bit rate, upload traffic volume, download traffic volume, radio channel utilization rate, network interference volume, frequency band utilization, channel utilization, device type, or a combination thereof. The telemetry data may include a subset of parameters for each device. In some cases, the telemetry data may be received by each or a subset of the plurality of devices. In some cases, the telemetry data may be received from a device from the plurality of devices (e.g., a gateway of the wireless network).

At Step 415, the computing device may input the plurality of telemetry data into a machine learning model. The machine learning model may be trained on telemetry data received from a plurality of wireless networks, and may be configured to generate a likelihood value for a device of a wireless network. In some cases, the telemetry data may be sent from an ingest layer (e.g., layer 310) to a batch layer (e.g., layer 320) for inputting into the machine learning model.

At Step 420, the computing device may determine likelihood values for the plurality of devices based on the telemetry data. The likelihood values may correspond to a current condition of a given device. The likelihood value may correspond to a likelihood that a given device of the wireless network is experiencing a connectivity issue, such as poor download speed. In some cases, the likelihood value may correspond to a likelihood that a given device of the wireless network is in use by a user at the time of the troubleshooting procedure. In some cases, a serving layer, such as serving layer 330 of FIG. 3, may query the machine learning model for likelihood scores for the plurality of devices of the wireless network. In some cases, the likelihood scores may be generated (e.g., outputted) by the machine learning model without prompting, such that the scores are generated based on either the reception of the indication the troubleshooting procedure is initiated, or based on the reception of the telemetry data for the plurality of devices.

At Step 425, the computing device may send the likelihood scores to a receiving device. The likelihood scores may be sent to the device that initiated the troubleshooting procedure for the wireless network, such as a mobile phone of a user. The likelihood score may associate a particular device of the wireless network with a likelihood value, as discussed above. In some cases, the receiving device may display an ordered ranking of the plurality of devices of the personal network according to the likelihood scores. For example, the ordered ranking may be a numerical ordering of the plurality of devices (e.g., 1^{st}, 2^{nd}, 3^{rd}, etc.).

At Step 430, the machine learning model may be updated based on the received telemetry data. Various weights associated with stored telemetry data (e.g., parameters) and devices may be updated or adjusted based on the received telemetry data. In some cases, the computing device may further receive results of the troubleshooting procedure for the wireless network, which may be inputted in the machine learning model for additional training. In some cases, the computing device may receive a second plurality of telemetry data corresponding to the plurality of devices, where the machine learning model is updated based on the second plurality of telemetry data. The updating may be implemented, for example, by a batch layer (e.g., layer 320 of FIG. 3).

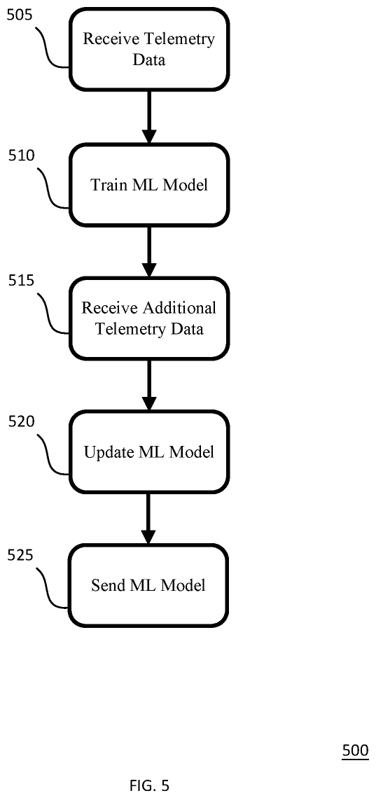

FIG. 5 shows an example method 500 for smart device ranking as discussed herein. The method of FIG. 5 may be implemented in one or more computing devices, such as computing device 200 of FIG. 2. In some cases, the method of FIG. 5 may be implemented by a processor of the one or more computing devices, and executable instructions according to the method may be stored on a memory of the one or more computing devices. The one or more computing devices may be part of a network, such as network 109 or of a personal network of a premises 102 of FIG. 1. The process may be implemented in a network environment having multiple users and respective user devices such as set-top boxes, smart televisions, tablet computers, smartphones, and/or any other suitable access device (e.g., display device 112, gateway 111, personal computer 114, wireless device 116, etc.), or any other desired computing devices. The shown method may in some cases be performed by one or more computing devices in the network. Although the steps of the method may be described with regard to a computing device, it should be understood that the various steps of the method may be handled by different computing devices without departing from the aspects and features described herein.

At Step 505, a computing device may receive a plurality of telemetry data. The plurality of telemetry data may correspond to a plurality of devices across a plurality of wireless networks. The telemetry data may include RSSI, physical layer bit rate, upload traffic volume, download traffic volume, radio channel utilization rate, network interference volume, frequency band utilization, channel utilization, device type, or a combination thereof. The telemetry data may include a subset of parameters for each device. In some cases, the telemetry data may be received by each or a subset of the plurality of devices. In some cases, the telemetry data may be received from a device from a corresponding plurality of devices (e.g., a gateway of a corresponding wireless network).

The plurality of personal devices may include devices wiredly or wirelessly connected in various personal networks, such as display devices 112 (e.g., televisions), additional STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), IoT devices such as security system devices, and any other desired devices.

At Step 510, the computing device may train the machine learning model on telemetry data received from a plurality of wireless networks, and may be configured to generate a likelihood value for a device of a wireless network. Training the model may include identifying and assigning weights and/or correlations for particular telemetry parameters. Training the model may also include, as input, outcomes associated with received telemetry data. For example, outcomes such as whether the user performed troubleshooting procedures on the device, whether the device experienced poor download speed, and the like. The likelihood value may correspond to a likelihood that a given device of the wireless network is experiencing a connectivity issue, such as poor download speed. In some cases, the likelihood value may correspond to a likelihood that a given device of the wireless network is in use by a user at the time of the troubleshooting procedure. In some cases, the telemetry data may be sent from an ingest layer (e.g., layer 310) to a batch layer (e.g., layer 320) for inputting into the machine learning model.

At Step 515, the computing device may receive additional telemetry data from a plurality of devices. The plurality of devices may include the personal devices of which the telemetry data of Step 505 correspond to. In some cases, the additional telemetry data may correspond to devices other than those which correspond to the telemetry data of Step 505.

At Step 520, the machine learning model may be updated based on the additional telemetry data. Various weights associated with stored telemetry parameters and devices may be updated or adjusted based on the additional telemetry data. In some cases, the computing device may receive results of troubleshooting procedures for one or more wireless networks, which may be inputted in the machine learning model for additional training. The updating may be implemented, for example, by a batch layer (e.g., layer 320 of FIG. 3).

At Step 525, the computing device may send the machine learning model to another device. For example, the other device may be a gateway of a particular network (e.g., when the machine learning model is prepared for implementation). In some cases, the other device may be a user device, such as a mobile phone. This may be particularly beneficial in assigning the machine learning model to a particular wireless network, as the model may be limited to receiving telemetry data from the particular wireless network.

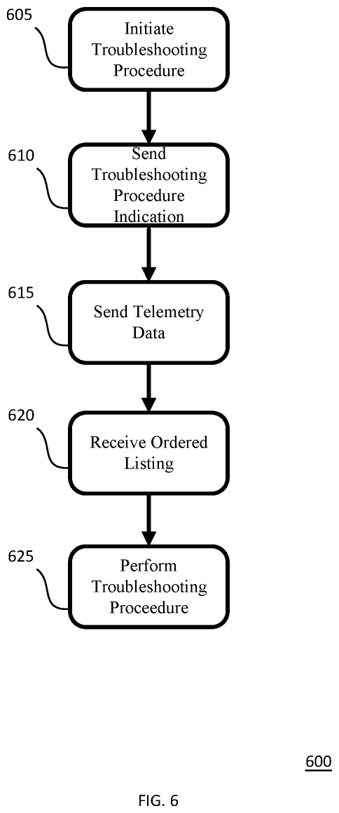

FIG. 6 shows an example method 600 for smart device ranking as discussed herein. The method of FIG. 6 may be implemented in one or more computing devices, such as computing device 200 of FIG. 2. In some cases, the method of FIG. 6 may be implemented by a processor of the one or more computing devices, and executable instructions according to the method may be stored on a memory of the one or more computing devices. The one or more computing devices may be part of a network, such as a personal network of a premises 102 of FIG. 1. The process may be implemented in a network environment having multiple users and respective user devices such as set-top boxes, smart televisions, tablet computers, smartphones, and/or any other suitable access device (e.g., display device 112, gateway 111, personal computer 114, wireless device 116, etc.), or any other desired computing devices. The shown method may in some cases be performed by one or more computing devices in the network. Although the steps of the method may be described with regard to a computing device, it should be understood that the various steps of the method may be handled by different computing devices without departing from the aspects and features described herein.

At Step 605, a computing device may initiate a troubleshooting procedure. A troubleshooting procedure may include testing a connectivity of at least one device. The troubleshooting procedure may include testing a latency time period for a device, a download speed for a device, and/or an upload speed for a device. In some cases, the troubleshooting procedure may be initiated by a troubleshooting application opening on the computing device (e.g., via a user).

At Step 610, the computing device may send an indication of the troubleshooting procedure. The indication may in some cases be a request for an ordered ranking of the personal devices of the wireless network. In some cases, the indication may be a notice that a troubleshooting application or service was opened or activated. In some cases, the indication may be sent to another device in the wireless network, such as a gateway of the network. In some cases, the indication may be sent to a device or entity external to the network, such as a device or entity of the external network 109 of FIG. 1.

At Step 615, the computing device may send telemetry data. The telemetry parameters may include RSSI, physical layer bit rate, upload traffic volume, download traffic volume, radio channel utilization rate, network interference volume, frequency band utilization, channel utilization, device type, or a combination thereof. In some cases, the telemetry data may include a subset of parameters for each device of the wireless network. In some cases, the telemetry data may correspond to the computing device.

At Step 620, the computing device may receive an ordered listing for the plurality of devices of the wireless network. The ordered listing may associate a particular device of the wireless network with a likelihood value, as discussed above. In some cases, the ordered listing may be a numerical ordering of the plurality of devices (e.g., 1^{st}, 2^{nd}, 3^{rd}, etc.). The ordered listing may correspond to likelihood values for the plurality of devices outputted from a machine learning model. The likelihood values may correspond to a likelihood that a given device of the wireless network is experiencing a connectivity issue, such as poor download speed. In some cases, the likelihood value may correspond to a likelihood that a given device of the wireless network is in use by a user at the time of the troubleshooting process.

At Step 625, the troubleshooting procedure may be implemented according to the ordered listing. In some cases, the ordered listing may be displayed, via a display, of the computing device. In some cases, the troubleshooting procedure may be a selective process, where one or more computing devices of the wireless network may be selected for troubleshooting purposes. In these cases, the plurality of wireless devices may be displayed according to the ordered ranking and for the selection process (e.g., by a user). In other cases, the troubleshooting procedure may be automatic (e.g., testing each device of the wireless network). In these cases, the computing device may perform the troubleshooting process (e.g., sending instructions to a corresponding gateway for performing the troubleshooting process) according to the ordered listing (e.g., testing the 1^{st} ordered device, testing the 2^{nd} ordered device, etc.).

Components are described herein that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as determined data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present embodiments may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving, by a gateway of a personal network and belonging to a computing system, an indication that a troubleshooting procedure is initiated for the personal network comprising a plurality of devices;
receiving, by the gateway, a plurality of telemetry data corresponding to the plurality of devices;
determining, by the computing system and based on the plurality of telemetry data, a likelihood value for each of the plurality of devices corresponding to an anticipated condition of a given device of the plurality of devices;
sending, by the gateway, an ordered ranking for the plurality of devices and according to the determined likelihood value for each of the plurality of devices; and
causing the troubleshooting procedure to be performed on at least a subset of the plurality of devices according to the ordered ranking.

2. The method of claim 1, wherein the anticipated condition comprises whether a device of the plurality of devices is experiencing a connectivity issue in the personal network.

3. The method of claim 1, wherein the anticipated condition comprises whether a device of the plurality of device is in use by a user.

4. The method of claim 1, wherein the determining is performed by a trained model of the computing system.

5. The method of claim 4, further comprising:
receiving a set of results of the troubleshooting procedure, wherein the trained model is updated according to the set of results.

6. The method of claim 4, wherein the trained model is updated based on the received plurality of telemetry data.

7. The method of claim 4, further comprising:
receiving, by the computing system, a second plurality of telemetry data corresponding to the plurality of devices, wherein the trained model is updated based on the second plurality of telemetry data.

8. The method of claim 7, wherein the second plurality of telemetry data are received according to a sampling schedule.

9. The method of claim 1, wherein the sending the ordered ranking is to a device of the plurality of devices.

10. The method of claim 9, wherein the device comprises a mobile phone.

11. The method of claim 1, wherein the computing system comprises a device of the personal network.

12. (canceled)

13. The method of claim 1, further comprising:
receiving, by the computing system, a machine learning model prior to the receiving the indication that the troubleshooting process is initiated.

14. The method of claim 13, wherein the machine learning model is trained according to a set of telemetry data of a plurality of devices of a plurality of personal networks.

15. The method of claim 1, wherein the plurality of telemetry data comprise RSSI, physical layer bit rate, upload traffic volume, download traffic volume, radio channel utilization rate, network interference volume, frequency band utilization, channel utilization, device type, or a combination thereof.

16. A method comprising:
initiating, by a device of a personal network comprising a plurality of devices, a troubleshooting procedure for the personal network;
receiving, by the device and from a gateway of the personal network, an ordered ranking for the plurality of devices and according to a likelihood value for each of the plurality of devices, wherein the each likelihood value corresponds to an anticipated condition of a given device of the plurality of devices; and
causing the troubleshooting to be performed for the personal network according to the ordered ranking.

17. (canceled)

18. The method of claim 16, further comprising:
sending, by the device and to the computing system, an indication of the troubleshooting procedure.

19. The method of claim 16, wherein the plurality of telemetry data comprise RSSI, physical layer bit rate, upload traffic volume, download traffic volume, radio channel utilization rate, network interference volume, frequency band utilization, channel utilization, device type, or a combination thereof.

20. A computing system, comprising:
a processor, and
a memory storing computer-executable instructions that, when executed by the processor, cause the computing system to:
receive, by gateway of a premises belonging to the computing system, an indication that a troubleshooting procedure is initiated for a personal network comprising a plurality of devices;
receive, by the gateway, a plurality of telemetry data corresponding to the plurality of devices;
determine, by the computing system and based on the plurality of telemetry data, a likelihood value for each of the plurality of devices corresponding to an anticipated condition of a given device of the plurality of devices; and
send, by the gateway, an ordered ranking for the plurality of devices and according to the determined likelihood value for each of the plurality of devices; and
cause the troubleshooting procedure to be performed on at least a subset of the plurality of devices according to the ordered ranking.
